(19) United States
(12) Patent Application Publication
(10) Pub. No.: US 2021/0213976 A1
(43) Pub. Date: Jul. 15, 2021

(54) AUTONOMOUS VEHICLE CONTROL WITH WHEEL DEPTH WATER CAPACITIVE FENDER MOLDING

(71) Applicant: Ford Global Technologies, LLC, Dearborn, MI (US)

(72) Inventors: Stuart C. Salter, White Lake, MI (US); John Robert Van Wiemeersch, Novi, MI (US); Pietro Buttolo, Dearborn Heights, MI (US); Steven Schondorf, Dearborn, MI (US); David Tippy, Ann Arbor, MI (US); Brian Bennie, Sterling Heights, MI (US)

(73) Assignee: Ford Global Technologies, LLC, Dearborn, MI (US)

(21) Appl. No.: 16/738,773

(22) Filed: Jan. 9, 2020

(51) Int. Cl. B60W 60/00; B60W 40/06; B60G 99/00; G07C 5/00; G05D 1/02; G01C 21/34; H04W 4/90

(52) U.S. Cl. CPC B60W 60/00182; B60W 40/06; B60G 99/002; G07C 5/006; G05D 1/0291; B60W 2556/45; G01C 21/3461; H04W 4/90; B60W 2555/20; B60W 2422/70; B60W 2530/00; G05D 1/0214

(57) ABSTRACT

This disclosure is generally directed to systems and methods for detecting a water depth level using capacitive sensors. The systems and methods disclosed herein receive a first capacitive signal from a first capacitive sensor in a wheel well of an autonomous vehicle (AV) and determine that the first capacitive signal exceeds a threshold value. The AV controller may be configured to determine water levels using a capacitive sensor system, and perform mitigating actions that cause the vehicle to either clean soiled capacitive sensors, or move the vehicle to a location that mitigates the risk of vehicle damage. Other mitigating actions may be performed as well, including disabling or powering down critical vehicle components when the vehicle cannot be moved to another location, providing means for emergency vehicle exit, and sending warning messages to the fleet control server, to occupants of the AV, or to other emergency personnel.

### TECHNICAL FIELD

The present disclosure relates to a capacitive depth sensor system and method for use in an autonomous vehicle environment.

### BACKGROUND

The ability to determine when a vehicle's engine will stall, or electrical function will be compromised, as it is moving through water is oftentimes difficult. Autonomous vehicles driving through flooded terrain must contemporaneously evaluate possible routes that avoid flood water that exceeds operating limitations of the vehicle.

Some water depth sensing technologies use ultrasonic sensors to detect and alert the operator of the vehicle as they are driving through flooded terrain. However, these sensors may not have the same precision as capacitive based sensors, and may be of limited use to an autonomous driving system when making determinations for navigational routes and taking mitigating actions when flood waters are encountered on routes.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an exemplary capacitive depth sensor system in accordance with the present disclosure.

FIG. 2 depicts an illustrative capacitive water depth sensor system integrated into a vehicle wheel well molding in accordance with the present disclosure.

FIGS. 3A and 3B depict an illustrative capacitive water depth sensor system integrated into a vehicle wheel well molding in accordance with the present disclosure.

FIG. 4 is a graphical representation of a capacitive water depth sensor system detecting air in a vehicle wheel well molding in accordance with the present disclosure.

FIG. 5 is a graphical representation of a capacitive water depth sensor system detecting water droplets in a vehicle wheel well molding in accordance with the present disclosure.

FIG. 6 is a graphical representation of a capacitive water depth sensor system detecting environmental substances in a vehicle wheel well molding in accordance with the present disclosure.

FIG. 7 is a graphical representation of a capacitive water depth sensor system detecting water in a vehicle wheel well molding in accordance with the present disclosure.

FIGS. 8A, 8B, and 8C depict an illustrative capacitive water depth sensor system integrated into a vehicle wheel well molding in accordance with the present disclosure.

FIG. 9A is a graphical representation of a capacitive water depth sensor system detecting water in a vehicle wheel well molding in accordance with the present disclosure.

FIG. 9B depicts an illustrative capacitive water depth sensor system integrated into a vehicle wheel well molding in accordance with the present disclosure.

FIG. 10 is a flowchart of an example method of the present disclosure related to detecting water in a vehicle wheel well molding in accordance with the present disclosure.

FIG. 11 depicts an illustrative architecture for an autonomous vehicle control system in accordance with the present disclosure.

FIG. 12 illustrates an example embodiment of an autonomous vehicle fleet operating in accordance with the present disclosure.

FIG. 13 is a flowchart of another example method of the present disclosure related to controlling an autonomous vehicle using the capacitive water depth sensor system in accordance with the present disclosure.

### DETAILED DESCRIPTION

### Overview

The systems and methods disclosed herein are configured to detect water depth levels under and around a vehicle as it is driven in flooded terrain using a capacitive water depth sensor system. The capacitive water depth sensor system can be tuned to operate with very low power consumption and, as such, can be used to continuously monitor for water and flooding while the vehicle is parked for extended periods of time. In one embodiment, the capacitive water depth sensor system includes a plurality of capacitive sensors that are integrated into a cavity in the wheel well molding of the vehicle—with gaps to allow air to escape from the top of the wheel well molding. In another embodiment, the capacitive water depth sensor system includes a plurality of capacitive sensors that are integrated directly into the wheel well molding. The capacitive sensors are integrated into the cavity of the wheel well molding by way of application of a conductive primer to the plastic of the wheel well molding. The conductive primer creates an electrostatic field similar to an electrostatic field generated between two plates housing a capacitive element. The electrostatic field may be created between capacitive sensors and the sheet metal of the vehicle to which the wheel well is attached. When groundwater rises within the space between the wheel well and the sheet metal of the vehicle, a processor connected to the capacitive sensors can detect the level of water based on a change in the electrostatic field based at least in part on the dielectric constant of water. In some embodiments, the primer may be painted on a portion of the vehicle other than the wheel well, and an electrostatic field may be generated by the primer. This embodiment may provide more sensitivity to moisture collecting on the sensor created by the primer painted on the vehicle.

In some embodiments, there may be a hole in the wheel well to allow air to escape as the water levels rise under the vehicle between the capacitive sensors and the sheet metal of the vehicle. The hole in the wheel well enables accurate reading of the water depth level because the dielectric constant of air is present between the capacitive sensors that are not submerged in water and the sheet metal. When a capacitive sensor is enclosed in an area without access to air, and there is water vapor in the enclosed area, the dielectric constant of the area between the plates housing the capacitive sensor is not exactly the same as air and therefore may give rise to inaccurate measurements.

The capacitive water depth sensor system also includes one or more processors that can analyze the intensity and pattern of a capacitive signal that is generated by the capacitive sensors, to determine when the capacitive sensors have accumulated dirt or snow. The one or more processors can further distinguish between splashes of water that are detected by the capacitive sensors as the vehicle is traveling over a wet surface, and when the vehicle is being driven in water. The one or more processors can further determine when the vehicle is simply sitting (parked) on a flooded terrain. To this end, the one or more processors may classify any sudden changes in a capacitive signal of the capacitive sensors, over a short period (less than a few seconds), as environmental substances begin to coat or stick to the capacitive sensors. Environmental substances may include but are not limited to water, snow, dirt, mud, and/or any other substances that have the ability to adhere to the capacitive sensors. The capacitive sensors may detect one or more environmental substances as the environmental substances are projected upward into the gap between the wheel well and the sheet metal, but do not remain in the gap. Accordingly, the one or more processors may classify these sudden changes in capacitive signal as noise signals that are filtered out of a capacitive signal corresponding to a rising water level underneath the vehicle. For example, as the water level underneath a vehicle increases as the vehicle moves from a wet surface where the tires of the vehicle are not submerged to a surface where the tires are completely submerged, the water droplets and any other environmental substances detected by the capacitive sensors are filtered out of the capacitive signal corresponding to rising water levels.

In one example embodiment, a nozzle attached to a liquid dispensing tank may be attached to a component connecting the wheel well to the sheet metal. The space or gap between the wheel well and the sheet metal may be referred to as a chamber. The one or more processors may send instructions to an actuator that may cause the dispensing tank to dispense a cleaning solution to the capacitive sensors via the nozzle to remove any environmental substances that adhere to the capacitive sensors. These environmental substances may include dirt, mud, snow, or ice. In some embodiments, the one or more processors may send a signal to a display in the cab of the vehicle instructing the operator of the vehicle to press a button on the touch display or elsewhere in the cab of the vehicle that will cause the cleansing solution to be dispensed onto the capacitive sensors. In other embodiments, the one or more processors may determine that the capacitive signal received from the capacitive sensors corresponds to a noisy capacitive signal, and may send a signal to the actuator to dispense the cleaning solution onto the capacitive sensors.

This disclosure applies to both the powertrain and electrical infrastructure within the vehicle. In some embodiments, the vehicle engine may include an internal combustion engine, battery electric vehicle (BEV), plug-in hybrid electric vehicle (PHEV), one or more turbines, or any other engine technology that propels a vehicle which, if exposed to rising water, may be compromised by the water of a certain depth. The sensors disclosed herein detect water depth levels so as to prevent the compromise of any supporting electrical drives, engine controls, and/or wiring infrastructure included in the vehicle. It should be noted that the word vehicle is inclusive of, but not limited to petrol-fueled cars, vans, buses, or trucks. The word vehicle also includes electric and/or hybrid cars, vans, buses, or trucks.

In some embodiments, additional capacitive sensors may be placed on or around the engine of the vehicle, or on certain areas around an electrical system of the vehicle. If a particular location of the engine or electrical system happens to be particularly sensitive to moisture, additional capacitive sensors may be placed in these locations to allow earlier detection to help prevent the engine from flooding or the electrical system from short-circuiting. These and other advantages of the present disclosure are provided in greater detail herein.

Embodiments described herein may further include the capacitive water depth sensor system in communication with an autonomous vehicle (AV) controller of an AV. The AV may operate independently, or be part of an AV fleet in communication with a fleet control server. The AV controller may be configured to determine water levels, and rates of rising water using the capacitive sensor system described herein, and perform a mitigating action that causes the vehicle to either clean malfunctioning sensors, or in cases of functional sensors that detect rising water, move the vehicle to a location that mitigates damage risk. Other mitigating actions may be performed as well, including disabling or powering down critical components when the vehicle cannot be moved to another location and sending warning messages to the fleet control server, to occupants of the AV, to other parties with equity in the vehicle or trip, or to emergency personnel.

### Illustrative Embodiments

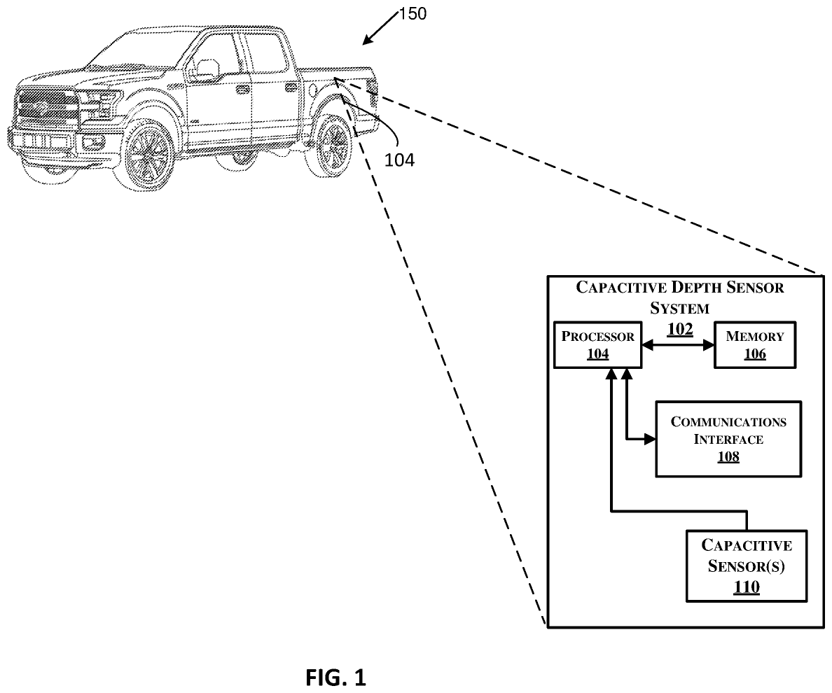

FIG. 1 depicts a capacitive depth sensor system 102 embedded in a fender portion of a vehicle 150. Capacitive depth sensor system 102 depicts an illustrative architecture in which techniques and structures of the present disclosure may be implemented. In various embodiments, the vehicles mentioned herein include a capacitive depth sensor system 102.

In some embodiments, the capacitive depth sensor system 102 comprises a processor 104, memory 106, and communications interface 108. The memory 106 stores instructions that are executed by the processor 104 to perform aspects of the discussed water depth condition analysis and generate the warnings disclosed herein. When referring to operations executed by the capacitive depth sensor system 102, it will be understood that this includes the execution of instructions by the processor 104.

The capacitive depth sensor system 102 may be affixed to the inside of a fender portion 104 of a vehicle 150. For example, the capacitive depth sensor system may be affixed to the inside of the fender portion 104. The capacitive depth sensor system 102 may be implemented on a printed circuit board (PCB).

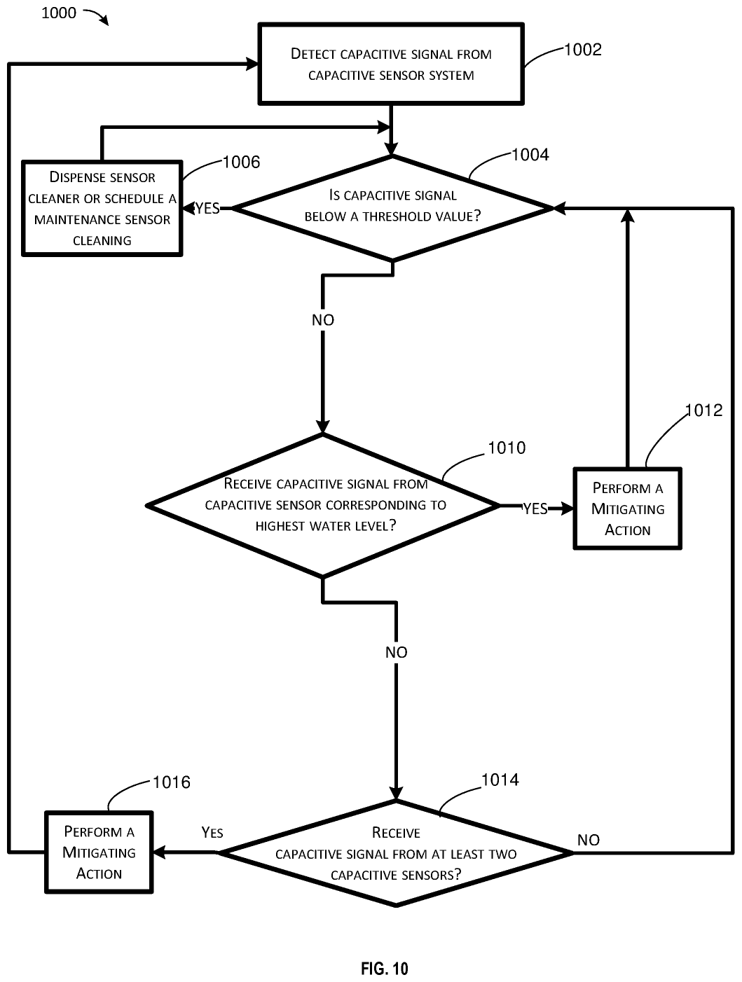

The processor 104 may perform the same functions as those described with general reference to the processor throughout the application. That is, the processor may perform the blocks in FIG.10. Capacitive sensor(s) 110 may comprise a first capacitive sensor and a second capacitive sensor as discussed herein. The processor 104 may receive signals from a detector circuit, that may be included in the capacitive depth sensor system 102, which indicates when the capacitance of one or both capacitive sensor(s) 110 has changed.

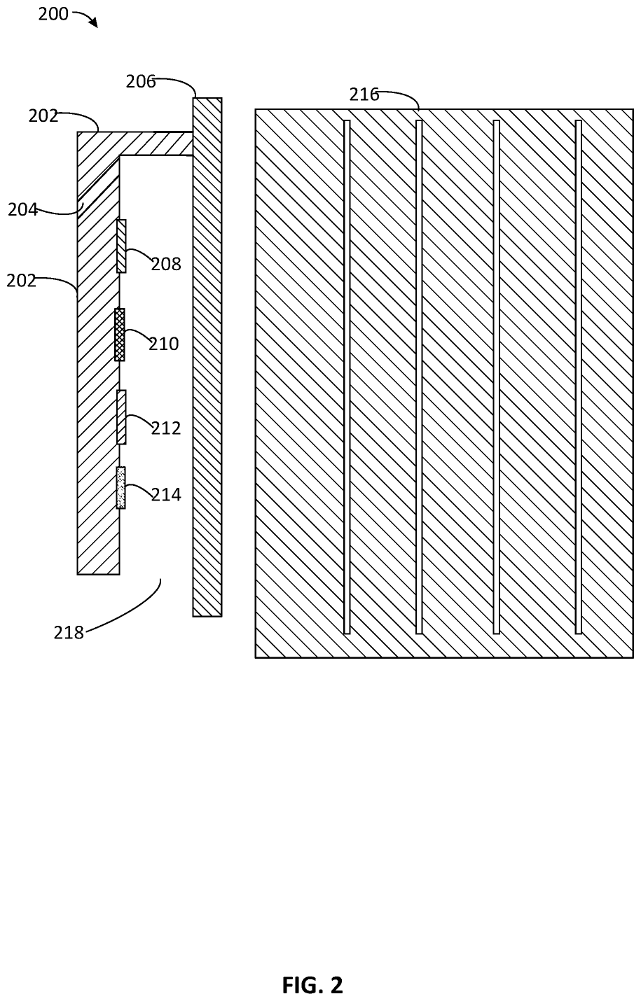

FIG. 2 depicts a cross-section of a fender portion 200 of a vehicle in which techniques and structures of the present disclosure may be implemented. The fender portion 200 may also be referred to as a wheel well and may include a wheel 216, fender molding 202, sheet metal 206, capacitive sensor 208, capacitive sensor 210, capacitive sensor 212, capacitive sensor 214, air hole 204, and gap 218. The fender molding 202 may be comprised of plastic and may be treated with a conductive primer that works especially well for plastic surfaces in order to create a capacitive element. In some embodiments, instead of the conductive primer there may be a metal or other conductive pad used in place of the conductive primer. That is, before or after manufacturing, a plastic insert is molded into or attached to the fender molding 202, one or more portions of the plastic may be treated with the conductive primer. The location of the fender molding 202 corresponding to the capacitive sensors 208, 210, 212, and 214, may be treated with the conductive primer in order to generate the corresponding capacitance. The air hole 204 may be pre-molded or cut out of the fender molding 202 in order to ensure that capacitive sensors 208, 210, 212, and 214 generate accurate capacitive signals. As mentioned above, the air hole 204 enables ambient air to enter or escape gap 218 to ensure that the capacitive sensors are not covered in water or water vapor that may form on those capacitive sensors in the absence of an air gap 218. For example, when capacitive sensors 214 and 212 are covered by water the dielectric constant associated with capacitive sensors 208 and 210 will correspond to that of the dielectric constant of air, whereas the dielectric constant of capacitive sensors 212 and 214 will correspond to the dielectric constant of water. If the air hole 204 was not disposed in the fender molding 202 and the vehicle was sitting in water up to the height of sensor 212, the water vapor could then collect on capacitive sensors 208 and 210, resulting in these capacitive sensors generating inaccurate readings. For instance, if enough water vapor collects on these capacitive sensors, one or more processors that receive signals from the capacitive sensors may determine that water levels may be starting to rise when in fact they are not. Further still, the one or more processors may even determine incorrectly that the vehicle is moving because water vapor is filling gap 218 thereby affecting the dielectric constant of those capacitive sensors.

The capacitive sensors 208, 210, 212, and 214 may be affixed to the fender molding 202. Water may rise through the gap 218 and may cause a change in the capacitive signal generated by these capacitive sensors as the water rises vertically in the gap 218. The capacitive sensors 208, 210, 212, and 214 may each generate an electrostatic field and a corresponding capacitive signal when there is no water in the gap 218. When there is no water in the gap 218, the capacitive signal generated by each capacitive sensors 208, 210, 212, and 214 is based at least in part on the dielectric constant of the ambient air. When there is water interacting with, or disturbing, the electrostatic field generated by a capacitive sensor based on the dielectric constant of the ambient air, the capacitive signal generated by the capacitive sensor is based at least in part on the additional dielectric constant of water. The dielectric constant of water is approximately 80 times that of air. Because the electric field is inversely proportional to the capacitance of a dielectric constant, and the dielectric constant of water is 80 times that of air, a decrease in the electrostatic field across a capacitive sensor will result in an increase in capacitance (increase in capacitive signal). This decrease in the electrostatic field may correspond to a positive numeric value. The one or more processors (not shown in FIG. 2) may be communicatively coupled to the capacitive sensors 208, 210, 212, and 214 on the fender portion 202. The one or more processors may be attached to the fender molding nearby the capacitive pads or conductive primer, and the one or more processors may be over-molded into the wheel well to protect it from the environment. By placing the capacitive pads closer to the one or more processors the less parasitic the capacitance signal will be, thereby yielding a better signal.

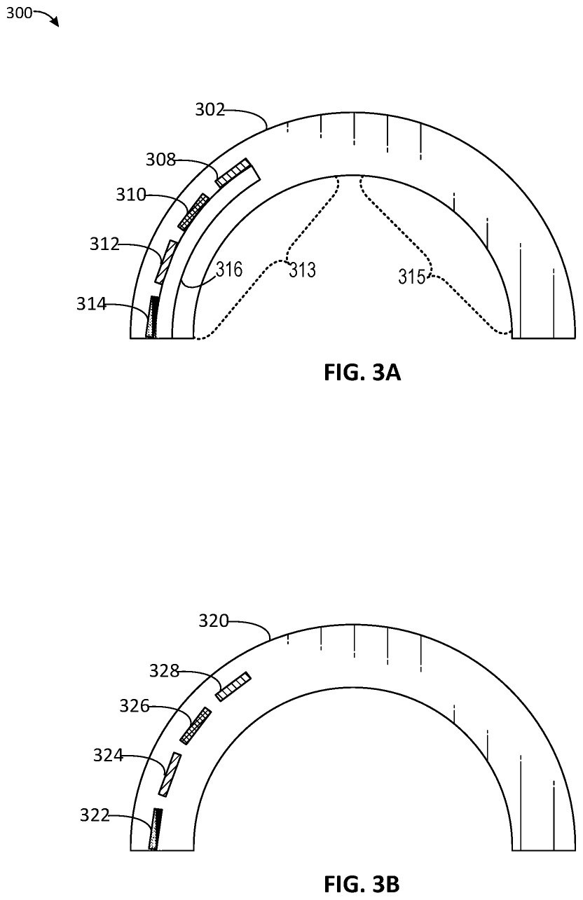

FIGS. 3A and 3B depict an illustrative capacitive water depth sensor system 300 integrated into a vehicle wheel well molding in accordance with the present disclosure. In some embodiments, the sensor system may be located on a leading arch 313 of the wheel well (i.e., closest to the front of the vehicle). The leading arch 313 may include capacitive sensors 308, 310, 312, and 314. In other embodiments, the sensory system may be located on a trailing arch 315. The sensor system may be placed in the leading arch 313 or the trailing arch 315 based at least in part on the body style and/or the height of the vehicle. The sensor system may be located on the leading arch 313 to enable the early detection of environmental substances. Placement of the sensor system on the leading arch 313 will help avoid water being displaced into the sensor system by a vehicle wheel as it is rotating thereby potentially causing a false water level indication. FIG. 3A illustrates a first embodiment of the arrangement of a plurality of capacitive sensors (capacitive sensors 308, 310, 312, and 314) on fender molding 302. The fender molding 302 may correspond to fender molding 202, shown in FIG. 2. In the embodiment of FIG. 3A, the capacitive sensors 308, 310, 312, and 314 are included in a cavity (cavity 316), which may comprise a plurality of gaps between each of the capacitive sensors to allow air to escape from between the capacitive sensors. The cavity 316 may be molded onto the backside of fender molding 302. That is, cavity 316 may be located on the same side of the fender molding 202 on which capacitive sensors 208, 210, 212, and 214 are located. It should be noted that capacitive sensors 308, 310, 312, and 314 have the same functionality as capacitive sensors 208, 210, 212, and 214. Environment 300 also illustrates a second embodiment in FIG. 3B of the arrangement of a plurality of capacitive sensors (capacitive sensors 322, 324, 326, and 328) on a fender molding 320. In this embodiment, there may be no cavity to house capacitive sensors 322, 324, 326, and 328. It should be noted that capacitive sensors 322, 324, 326, and 328 have the same functionality as capacitive sensors 208, 210, 212, and 214.

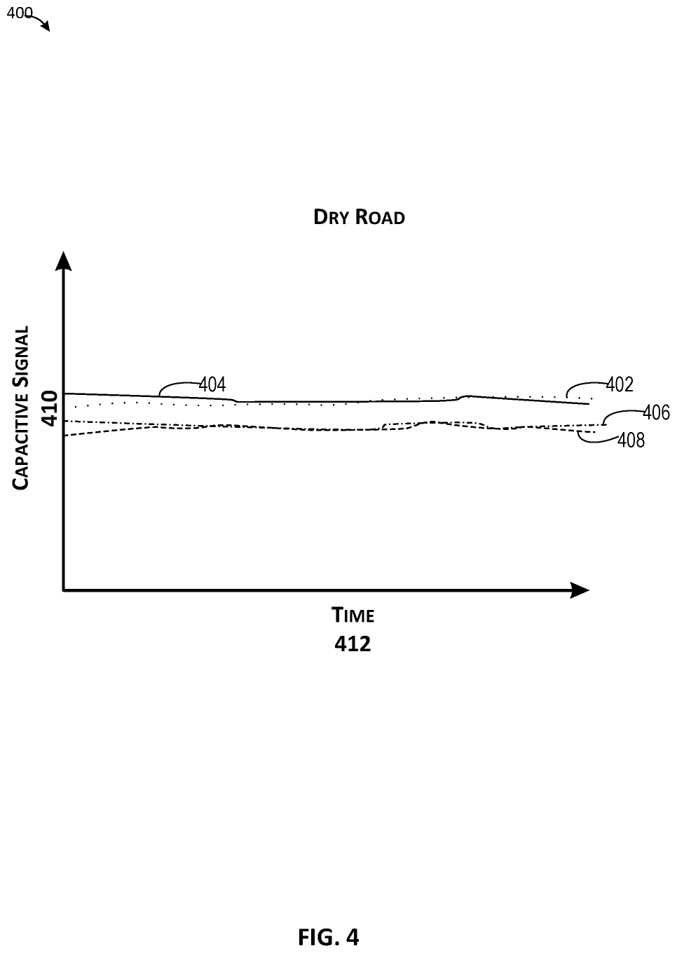

FIG. 4 is a graphical representation of a capacitive water depth sensor system detecting ambient air in a vehicle wheel well molding in accordance with the present disclosure. Graph 400 depicts capacitive signals corresponding to capacitive sensors 208, 210, 212, and 214 for a vehicle traveling on a dry road. The graph 400 includes a time axis (Time 412) and a capacitive signal axis measuring the amplitude of the capacitive signal (Capacitive Signal 410) of capacitive sensors 208, 210, 212, and 214. For example, capacitive sensor 214 may generate a capacitive signal corresponding to capacitive signal 402. Capacitive sensor 212 may generate a capacitive signal corresponding to capacitive signal 404. Capacitive sensor 210 may generate a capacitive signal corresponding to capacitive signal 406. Capacitive sensor 208 may generate a capacitive signal corresponding to capacitive signal 408. Because air is the dielectric interacting with the electrostatic field generated by capacitive sensors 208, 210, 212, and 214 on a dry road, capacitive signals 402, 404, 406, and 408 are similar in amplitude over time. Furthermore, the capacitive signals are nearly constant (straight line from left to right) because there is no change to the dielectric constant over time. Any changes to the dielectric constant may be due to random environmental substances that are projected upward into gap 218 (as shown in FIG. 2) which may be detected by the capacitive sensors.

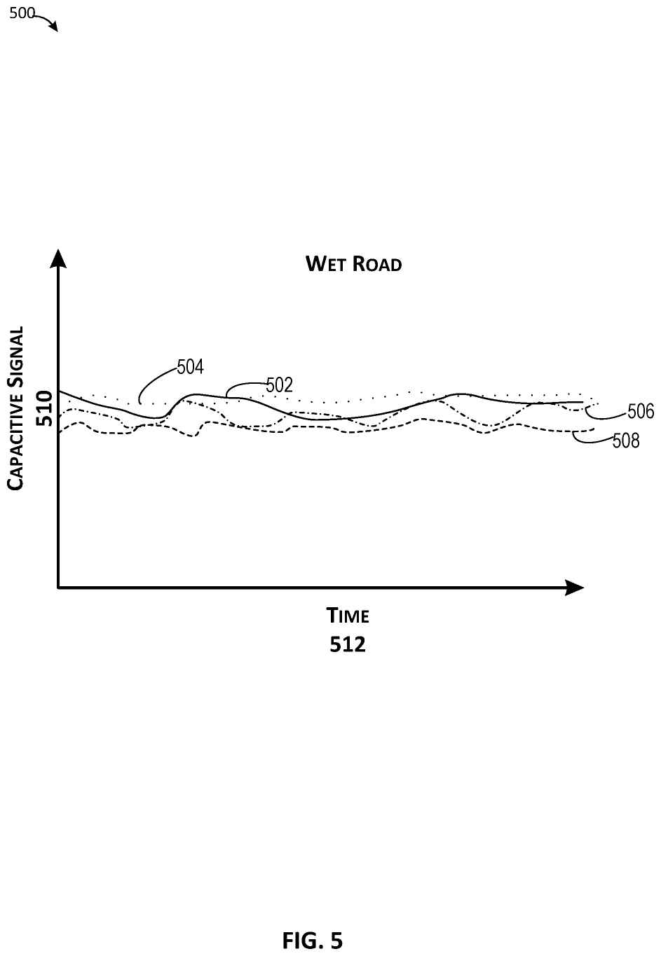

FIG. 5 is a graphical representation of a capacitive water depth sensor system detecting water droplets in a vehicle wheel well molding in accordance with the present disclosure. Graph 500 depicts signals corresponding to capacitive sensors 208, 210, 212, and 214 for a vehicle traveling on a wet road. Graph 500 includes a time axis (Time 512) and a capacitive signal axis measuring the amplitude of the capacitive signal (Capacitive Signal 510) of capacitive sensors 208, 210, 212, and 214. For example, capacitive sensor 214 may generate a capacitive signal corresponding to capacitive signal 502. Capacitive sensor 212 may generate a capacitive signal corresponding to capacitive signal 504. Capacitive sensor 210 may generate a capacitive signal corresponding to capacitive signal 506. Capacitive sensor 208 may generate a capacitive signal corresponding to capacitive signal 508. Because ambient air is still the dielectric interacting with the electrostatic field generated by capacitive sensors 208, 210, 212, and 214, even on a wet road, capacitive signals 402, 404, 406, and 408 are similar in amplitude over time. There will be some variability in the capacitive signals generated by the capacitive signals, and this will be due to the dielectric associated with water droplets from the wet road that interact with the electrostatic field generated by each of the capacitive sensors. Because the distribution of water droplets that are projected into gap 218, and therefore interact with the electrostatic fields of the capacitive sensors is random, the variance of the capacitive signals corresponding to the capacitive signals for each sensor may also follow this same random distribution. Accordingly, the average value (or expected value) across all of the capacitive sensors may be the same because the capacitive signals are based on the same random distribution.

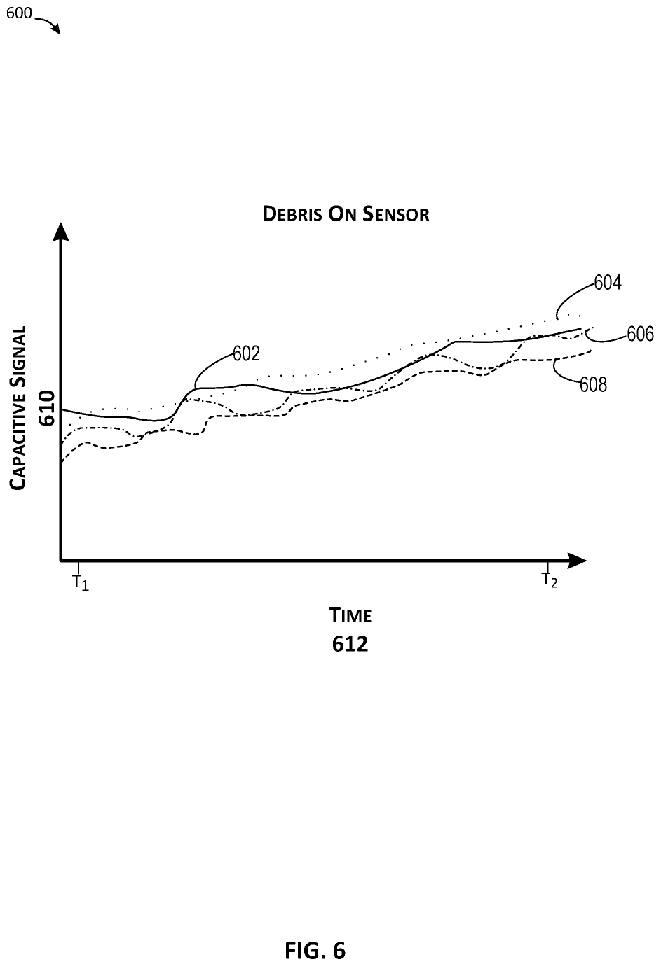

FIG. 6 is a graphical representation of a capacitive water depth sensor system detecting environmental substances in a vehicle wheel well molding in accordance with the present disclosure. Graph 600 depicts signals corresponding to capacitive sensors 208, 210, 212, and 214 for a vehicle traveling on a road with environmental substances accumulating on the capacitive sensors. The environmental substances may include dirt, mud, snow, ice or a combination of these and other environmental substances. Graph 600 includes a time axis (Time 612) and a capacitive signal axis measuring the amplitude of the capacitive signal (Capacitive Signal 610) of capacitive sensors 208, 210, 212, and 214. For example, capacitive sensor 214 may generate a capacitive signal corresponding to capacitive signal 602. Capacitive sensor 212 may generate a capacitive signal corresponding to capacitive signal 604. Capacitive sensor 210 may generate a capacitive signal corresponding to capacitive signal 606. Capacitive sensor 208 may generate a capacitive signal corresponding to capacitive signal 608. Because ambient air is the dielectric interacting with the electrostatic field generated by capacitive sensors 208, 210, 212, and 214, before there is any environmental substance on the capacitive sensors (at time t1), the amplitude of the capacitive signals generated by the capacitive sensors is less than it is after environmental substances have collected on the capacitive sensors (at time t2). This is due to the fact that dirt and other environmental substances have a dielectric constant that is different than air, and the dirt and other environmental substances are dielectrics that will interact with or disturb, the electrostatic field generated by the capacitive sensors from the ambient air, and thereby cause the capacitive signal to increase over time (as environmental substances are collected).

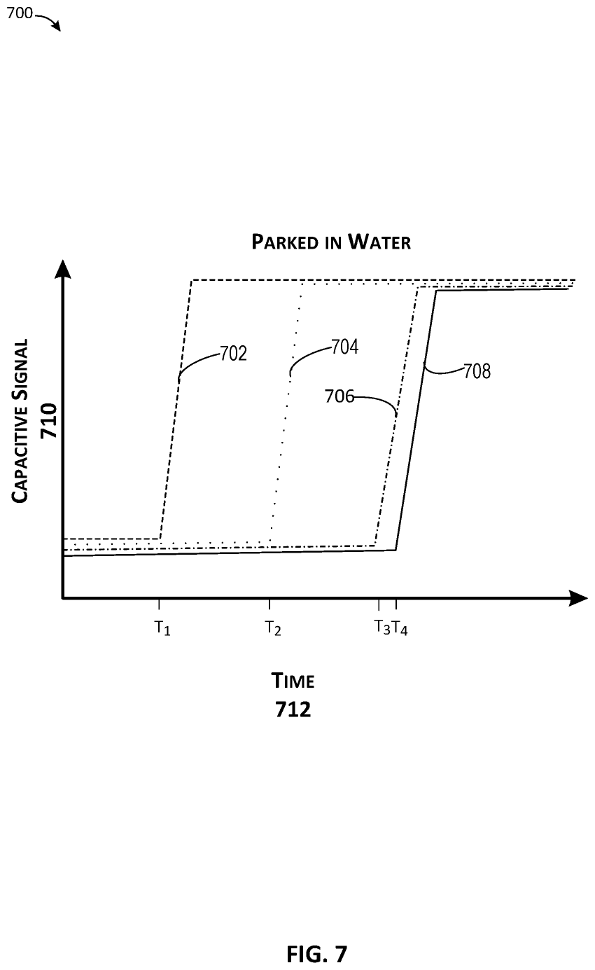

FIG. 7 is a graphical representation of a capacitive water depth sensor system detecting water in a vehicle wheel well molding in accordance with the present disclosure. Graph 700 depicts signals corresponding to capacitive sensors 208, 210, 212, and 214 for a vehicle parked in water. Graph 700 includes a time axis (Time 712) and a capacitive signal axis measuring the amplitude of the capacitive signal (Capacitive Signal 710) of capacitive sensors 208, 210, 212, and 214. For example, capacitive sensor 214 may generate a capacitive signal corresponding to capacitive signal 702. Capacitive sensor 212 may generate a capacitive signal corresponding to capacitive signal 704. Capacitive sensor 210 may generate a capacitive signal corresponding to capacitive signal 706. Capacitive sensor 208 may generate a capacitive signal corresponding to capacitive signal 708. As the vehicle travels forward, and the surface water level rises, the capacitive signal for each capacitive sensor will increase from zero to a maximum value. For example, as water eclipses capacitive sensor 214, capacitive signal 702 will increase to maximum amplitude. Because capacitive sensor 214 is the capacitive sensor closest to the ground, as shown in FIG. 2, the capacitive signal corresponding to capacitive sensor 214 will increase from zero to its maximum, at time tl, value first because it is the first capacitive sensor to come into contact with the surface water. As water eclipses capacitive sensor 212, capacitive signal 704 will correspondingly increase to a maximum amplitude. Because capacitive sensor 212 is the second closest capacitive sensor to the ground, as seen in FIG. 2, the capacitive signal corresponding to capacitive sensor 212 will increase from zero to its maximum value, at time t2, after capacitive signal 702 because it is the second capacitive sensor to come into contact with the water. As water eclipses capacitive sensor 210, capacitive signal 706 will increase to a maximum amplitude. Because capacitive sensor 210 is the third closest capacitive sensor to the ground, as shown in FIG. 2, the capacitive signal corresponding to capacitive sensor 210 will increase from zero to its maximum value, at time t3, after capacitive signal 704 because it is the third capacitive sensor to come into contact with the water. As water eclipses capacitive sensor 208, capacitive signal 708 will increase to a maximum amplitude. Because capacitive sensor 208 is the fourth closest capacitive sensor to the ground, as shown in FIG. 2, the capacitive signal corresponding to capacitive sensor 208 will increase from zero to its maximum value, at time t4, after capacitive signal 706 because it is the fourth capacitive sensor to come into contact with the water.

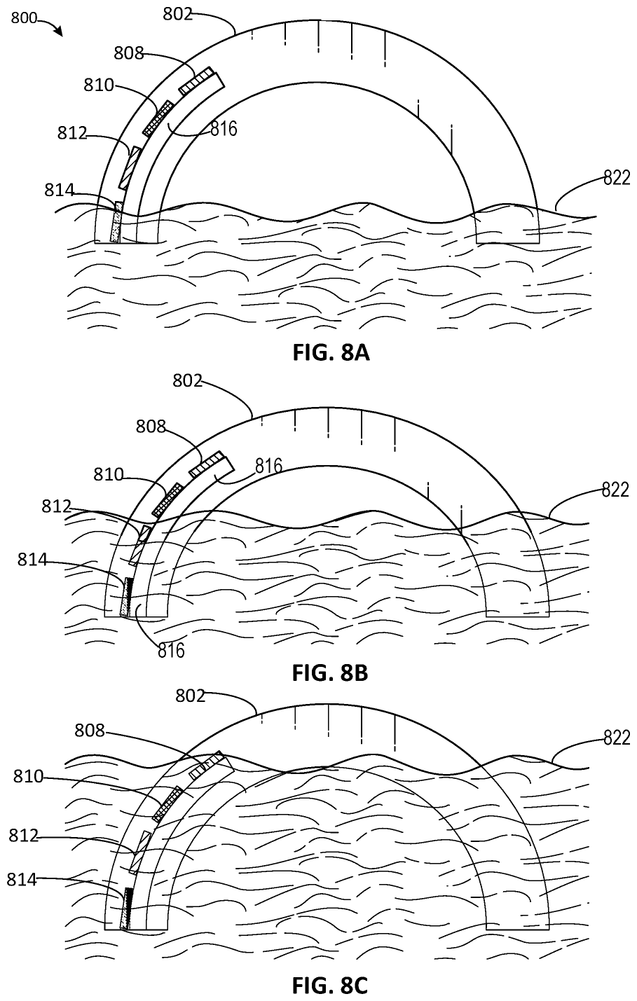

FIGS. 8A, 8B, and 8C depict an illustrative capacitive water depth sensor system integrated into a vehicle wheel well molding in accordance with the present disclosure. FIG. 8A depicts fender portion 802 on which cavity 816 is molded into, and capacitive sensors 814, 812, 810, and 808 are inlaid. Water 822 corresponds to water that rises to the level of capacitive sensor 814 at fender portion 802. Capacitive sensor 814 may correspond to capacitive sensor 214, and the capacitive signal generated by capacitive sensor 814 may correspond to capacitive signal 702. FIG. 8B depicts fender portion 802 on which cavity 816 is molded into, and capacitive sensors 814, 812, 810, and 808 are inlaid. The water 822 corresponds to water that rises above the level of capacitive sensor 814 to the level of capacitive sensor 812 at fender portion 802. Capacitive sensor 812 may correspond to capacitive sensor 212 (as shown in FIG. 2), and the capacitive signal generated by capacitive sensor 812 may correspond to capacitive signal 704. FIG. 8C depicts fender portion 802 on which cavity 816 is molded into, and capacitive sensors 814, 812, 810, and 808 are inlaid. The water 822 corresponds to water that rises above capacitive sensors 814, 812, 810 and further above capacitive sensor 808 at fender portion 802. Capacitive sensor 810 may correspond to capacitive sensor 210, and the capacitive signal generated by capacitive sensor 810 may correspond to capacitive signal 706. Capacitive sensor 808 may correspond to capacitive sensor 208, and the capacitive signal generated by capacitive sensor 808 may correspond to capacitive signal 708.

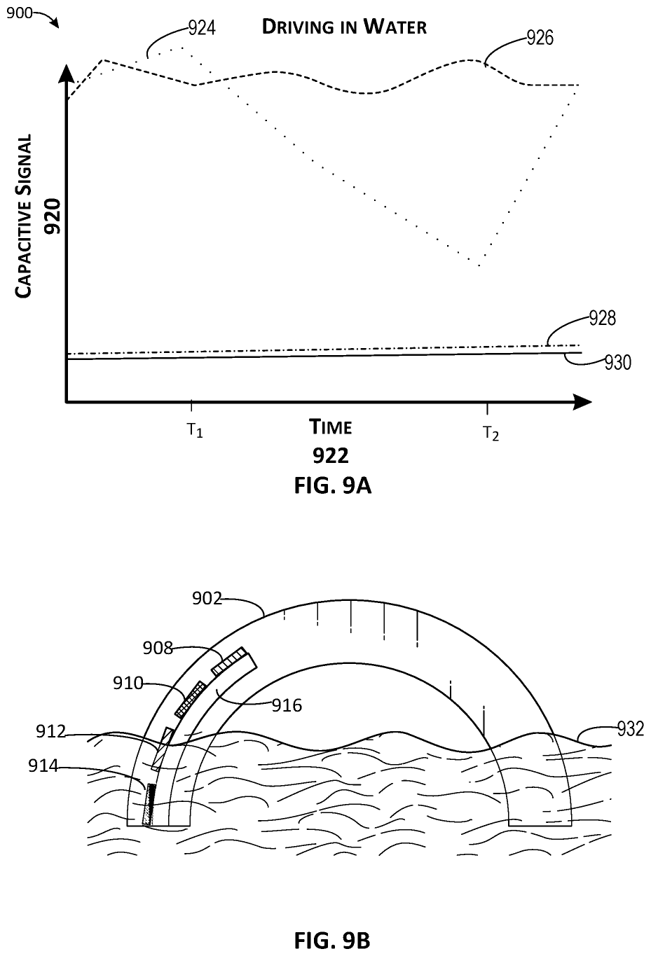

FIG. 9A is a graphical representation of a capacitive water depth sensor system detecting water in a vehicle wheel well molding in accordance with the present disclosure. Graph 900 depicts signals corresponding to capacitive sensors 908, 910, 912, and 914, in FIG. 9B, which correspond to capacitive sensors 208, 210, 212, and 214 (as shown in FIG. 2) respectively for a vehicle driving through water. Graph 900 includes a time axis (Time 922) and a capacitive signal axis measuring the amplitude of the capacitive signal (Capacitive Signal 920) of capacitive sensors 908, 910, 912, and 914. For example, capacitive sensor 914 may generate a capacitive signal corresponding to capacitive signal 926. Capacitive sensor 912 may generate a capacitive signal corresponding to capacitive signal 924. Capacitive sensor 910 may generate a capacitive signal corresponding to capacitive signal 928. Capacitive sensor 908 may generate a capacitive signal corresponding to capacitive signal 930. At time t1 the vehicle may have traveled over an object raising the vehicle and consequently raising capacitive sensor 912 above water 932 at a linear rate until time t2, thereby resulting in capacitive signal 924 dropping linearly over the same period of time. At t2, the vehicle may begin to descend into water 932 thereby causing capacitive sensor 912 to be submerged in water 932 and causing capacitive signal 924 to increase linearly from time t2 onward. This may indicate that the vehicle drove up out of a small valley filled with water and back down into another small valley with water. It should be noted that the slope of capacitive signal 924 between time tl and time t2 is linear indicating that the vehicle was moving at a relatively slow pace in driving through the water as the vehicle ascended out of the first valley. Similarly, as the vehicle drove down into the next small valley the operator of the vehicle was driving at a reasonable pace as indicated by the slope of capacitive signal 924 from t2 onward. When the vehicle accelerates, decelerates, and/or turns, water will slosh inside the gap 218, or on the exterior of the wheel well producing pronounced changes in capacitive signal levels and the variability in the capacitive signal. As such, large capacitive signal values associated with variability in the capacitive signal may be an indicator of driving on a flooded surface. Furthermore, a signal from the vehicle accelerometer may be used to match the pattern generated by the capacitive sensors.

FIG. 10 is a flowchart of an example method of the present disclosure related to detecting water in a vehicle wheel well molding in accordance with the present disclosure. At block 1002 the method may detect a capacitive signal from a capacitive sensor system in a vehicle. The capacitive sensor system may include a plurality of capacitive sensors coupled to one or more processors. The capacitive sensor system may detect a capacitive signal after one or more of the capacitive sensors generates a capacitive signal corresponding to an object with a dielectric constant associated with water (i.e., a capacitive sensor detects water). The method may progress to block 1004 and determine if the capacitive signal is below a threshold value. A sensor value that is below a threshold value may be indicative of foreign matter such as mud, tar, or other debris interfering with the function of the capacitive sensor system.

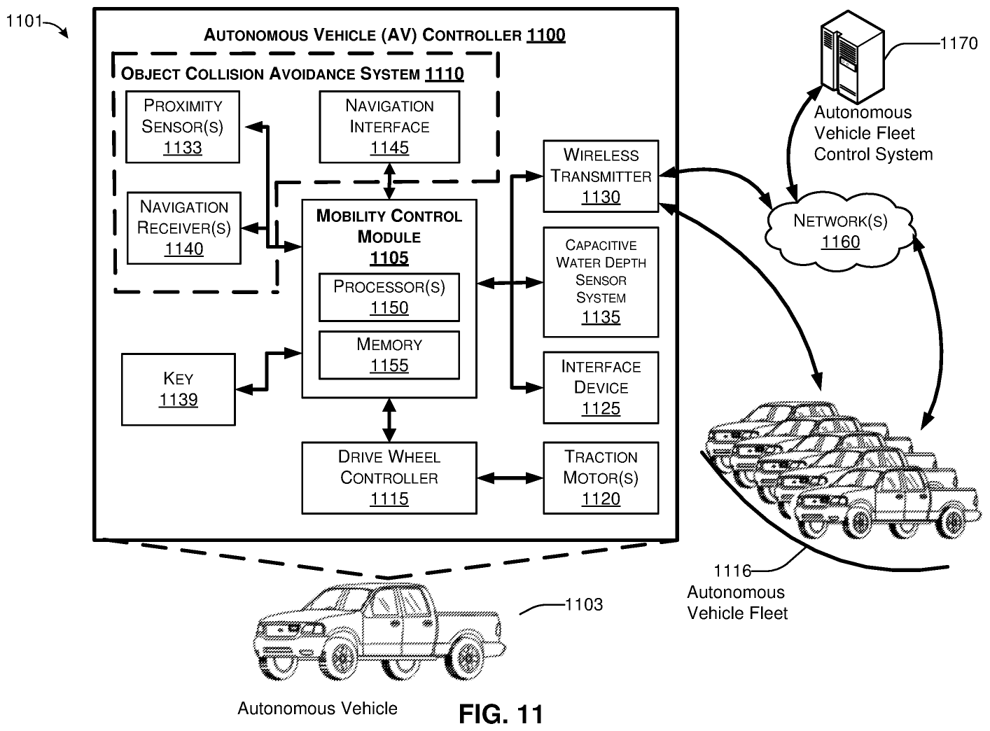

At block 1004, if the capacitive signal is below the threshold value (YES) the method may progress to block 1006, where the AV controller (e.g., the AV controller 1100 as described hereafter with respect to FIG. 11) may access the current status of the vehicle and the capacitive sensors to determine whether the AV controller will generate a control instruction that causes a sensor cleaning system to activate an actuator to spray a cleaning solution into a cap sense chamber in the wheel molding. In another aspect, the AV controller may determine that the sensors may not be suitably cleaned with actuation of the sensor cleaner alone, and may generate an instruction that schedules a manual sensor cleaning during the next maintenance visit. For example, in one embodiment, the AV may regularly visit a maintenance station (e.g., twice daily, once daily, three times weekly, etc.) to receive maintenance and repairs from a maintenance technician. Accordingly, generating the maintenance visit instruction may include sending a message to a scheduling computer (not shown in FIG. 10), scheduling an extended block of time for a maintenance visit to accommodate the required service, and my generate metadata for the maintenance personnel to review that can include details associated with the amount of cleaning necessary for the visit. In one aspect, a small amount of caked-on mud may require a smaller block of time than a thick dried block of dirt and mud, or a layer of tar, etc. If the capacitive signal is below a certain threshold value, that indicates that a dielectric of one or more objects in the vicinity of the capacitive sensors is much higher than water thereby indicating that the one or more objects may be an environmental substance such as snow. The environmental substance may also be mud, dirt, or another substance such as tar, paint, or some other foreign matter. The one or more substances may be covering the one or more sensors. After displaying the message, the method may progress back to block 1004.

In some embodiments, the AV controller 1100 may generate the signal to dispense the cleaning solution. In another embodiment, a remote administrative operator (not shown in FIG. 10) may receive a message from the AV controller indicative that one or more sensors may require cleaning and/or other maintenance. The remote administrative operator may generate an instruction message that, when received by the AV controller, may cause the AV controller to dispense the cleaning solution. Accordingly, the AV controller may send instructions to one or more processors associated with the capacitive sensor system in response to the instruction generated by the administrative operator. The AV controller may, in turn, send a signal to the actuator causing the actuator to dispense the cleaning solution.

At block 1004, if the capacitive signal is not below the threshold value (NO), the method may progress to block 1010 and the method may display an image on the display corresponding to a water depth level associated with the capacitive signal. The water depth level may be detected as explained above with reference to FIGS. 8A-8C and FIGS. 9A-9B. The display may be a graphical image indicating the level of water relative to the vehicle. In other embodiments, there may be cameras displaying the water that is around the vehicle.

The method may then progress to block 1010, where the AV controller determines whether a capacitive signal is received from a capacitive sensor corresponding to the highest water level. Responsive to determining that signal is received (YES), the method may progress to block 1012, and where the AV controller can perform one or more mitigating actions, which may include causing the vehicle to move to higher ground, and/or generating a message to occupants of the AV providing instructions for exiting the vehicle, etc. For example, determining that the capacitive sensor corresponds to the highest water level may correspond to the example depicted in FIG. 8C where water 822 exceeds capacitive sensors 808, 810, 812, and 814, and capacitive sensors 808, 810, 812, and 814 each generate a capacitive signal that corresponds to a maximum value because they are submerged by water 822.

The AV controller may also, in some aspects, perform mitigating actions that include displaying an instruction message or warning to vehicle occupants that inform them of actions being taken by the vehicle, such as rerouting a trip due to flood waters, etc. In some embodiments, the AV controller may send a message to the mobile device via an application service hosted by a server (i.e., a mobile application executing on the mobile device).

If, at block 1012, the AV controller determines that a capacitive signal is not received corresponding to the highest water level (NO), the AV controller determines whether a capacitive signal is received from at least two capacitive sensors as shown in block 1014. For example, the AV controller may determine whether the water 822 has exceeded capacitive sensors 814 and 812 as in FIG. 8B. If the AV controller determines that the water has exceeded at least two capacitive sensors (YES), the AV controller may perform a mitigating action at block 1016, which may include moving the vehicle to a location with less ground water, generating a help requested message to first responders, and/or displaying an instruction or information message to vehicle occupants. After performing the mitigation action, the AV controller may continue the detection loop as shown in block 1002. If the method determines that it does not receive a capacitive signal from at least two capacitive sensors (NO), then the method may progress to block 1004.

FIG. 11 depicts a block diagram of an operating environment 1101 and an autonomous vehicle (AV) 1103, that may operate in the field individually, and/or as a member of a fleet 1116 of autonomous vehicles. Vehicle 1103 may include an AV controller 1100 that provides object collision avoidance, mobility control, and control infrastructure associated with a capacitive water depth sensor system 1135. Autonomous vehicle 1103 (hereafter vehicle 1103) may be a manually drivable vehicle, or in a preferred embodiment, may be configured to operate in a fully autonomous (e.g., driverless) mode (e.g., level-5 autonomy) or in one or more partial autonomy modes.

Examples of partial autonomy modes can include autonomy levels 1 through 4 as understood in the art of autonomous driving technology. By way of a short overview of the levels of autonomy, a vehicle having Level-1 autonomy may include a single automated driver assistance feature, such as for steering or acceleration. Adaptive cruise control is one such example of a Level-1 autonomous system. Level-2 autonomy in vehicles may provide partial automation of steering and acceleration functionality, where the automated system(s) are supervised by a human driver that performs non-automated operations such as braking and other controls. Level-3 autonomy in a vehicle can provide conditional automation and control of driving features, such as, for example, “environmental detection” capabilities that can make informed decisions for itself. For example, a Level-3 autonomous vehicle may control accelerating past a slow-moving vehicle, while a driver remains ready to retake control of the vehicle if the system is unable to execute the task. Level 4 autonomous vehicles may generally include a high level of autonomy and can operate independently of a human driver, but still include manual controls for a human-operator override. Level-4 automation may also enable a self-driving mode to intervene responsive to a predefined conditional trigger, such as a road hazard or a system failure. A vehicle with Level-5 autonomy may not include any human vehicle controls and is generally configured to operate with non-human control system(s). Vehicle 1103 may include any level of autonomy. In a preferred embodiment, vehicle 1103 may be a Level-4 or Level-5 autonomous vehicle.

AV controller 1100 may generally include an object collision avoidance system 1110, and a capacitive water depth sensor system 1135 configured to interface with vehicle drive, communication, sensory, and other systems, to receive control instructions from mobility control module 1105 for navigating and driving vehicle 1103 according to embodiments of the present disclosure. Example vehicle systems may include a drive wheel controller 1115. The object collision avoidance system 1110 may communicate one or more control signals to internal drive components and systems, such as a drive wheel controller 1115 that controls one or more traction motor(s) 1120, and interfaces with external systems and vehicles via a wireless transmitter 1130, which may be disposed in communication with the mobility control module 1105.

The mobility control module 1105 may include one or more processor(s) 1150, and a memory 1155. Processor(s) 1150 may be one or more commercially available general-purpose processor(s), such as a processor from the Intel® or ARM® architecture families. In some aspects, mobility control module 1105 may be implemented in a system on a chip (SoC) configuration, to include other system components such as RAM, flash storage and I/O buses. Alternatively, mobility control module 1105 can be implemented using purpose-built integrated circuits, or any other suitable technology now known or later developed. Mobility control module 1105 also includes a memory 1155.

Mobility control module 1105 may receive navigational data from navigation receiver(s) 1140, the proximity sensor(s) 1133, and the capacitive water depth sensor system 1135, determine a navigational path from a first location to a second location based on water depth information, and provide instructions to the drive wheel controller 1115 for autonomous and/or semi-autonomous operation that moves the vehicle 1103 to a location with an operable water depth. Operable water depth, as described in greater detail hereafter, may be a maximum water depth at which the vehicle 1103 is able to operate within its intended design.

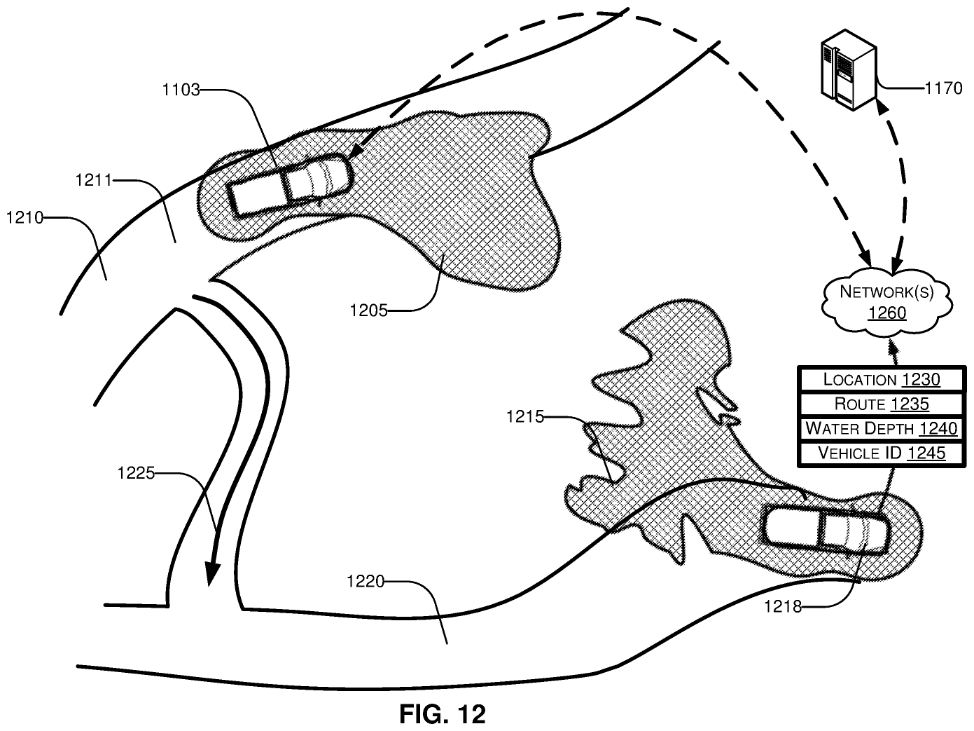

The memory 1155 may include executable instructions implementing the basic functionality of the capacitive water depth sensor system 1135, and/or a database of locations in a particular geographic area. An example geographic area is described using an example discussed with respect to FIG. 12.

The capacitive water depth sensor system 1135 may be substantially similar or identical to the capacitive depth sensor system 102 described with respect to FIG. 1. Capacitive water depth sensor system 1135 may be embedded in a fender portion of the vehicle 1103, and/or be embedded in other areas of the vehicle 1103 such that the AV controller 1100 may receive water depth information that includes water depth levels associated with water-indicating capacitive signals of the capacitive water depth sensor system 1135.

The object collision avoidance system 1110 may be disposed in communication with the capacitive water depth sensor system 1135, and may include one or more proximity sensor(s) 1133, one or more navigation receiver(s) 1140, and a navigation interface 1145 through which users of the vehicle 1103 may receive information associated with water depth surrounding the vehicle 1103, receive information from other vehicles in an autonomous vehicle fleet 1116, with which vehicle 1103 may be associated. Mobility control module 1105 may communicate wheel engagement instructions, braking instructions, and other information to the drive wheel controller 1115, including signals for control of the one or more traction motor(s) 1120.

In an example embodiment, the mobility control module 1105 may further include a key 1139, which may be configured to activate operation of the vehicle 1103. The key 1139 may be a physical key or may be an identification code or a password entered by a user via a touch screen interface (e.g., the interface device 1125). The identification code may be associated with a service provider (not shown in FIG. 11) that operates or controls an autonomous vehicle fleet 1116 through an autonomous vehicle fleet control server 1170. In other aspects, the identification code may be associated with an individual that rents the autonomous vehicle 1103, an individual owner of the vehicle 1103, and/or a subscriber to multiple vehicles in the autonomous vehicle fleet 1116, which may be associated with the service provider, etc. The identification code may further enable a user to navigate a specific geographic region authorized by the service provider, such as, for example, within a geofenced area (not shown in FIG. 11) or within a specific geographic region, where the specific region is associated with the identification code.

The vehicle 1103 may communicate with one or more other AVs in fleet 1116 in various ways, including via an indirect communication channel using network 1160, and/or via a direct communication channel that communicates directly between the vehicle 1103 and other vehicles of the fleet 1116, such as AV 1218 as depicted in FIG. 12.

The wireless transmitter 1130 may embody any known or later known technology protocol, using one or more telecommunications, vehicle-to-vehicle, or other communication protocols to communicate with one or more other autonomous vehicles in the fleet 1116 and/or with the autonomous vehicle fleet control server 1170 using a wireless communication network such as, for example, network 1160. For example, the AV controller 1100 may receive water depth information from the capacitive water depth sensor system 1135. The water depth information may include an operative water depth associated with the capacitive sensor mounted at the top-most portion of the fender with respect to a surface of the ground. More particularly, the operative water depth may be associated with the capacitive signal from that sensor. Accordingly, the AV controller 1100 may generate vehicle control instructions for performing a mitigating action based on the second water depth information.

In one example, the AV controller 1100 may send a message to the fleet control server 1170 via network 1160, and receive a response message from fleet control server 1170 via the network 1160. The message may indicate a route recommendation for moving vehicle 1103 to a location with an operable water depth, where another AV in fleet 1116 provides water depth information to fleet control server 1170, and the second AV water depth information is used in the analysis for moving vehicle 1103 to the second location.

Network 1160 may be and/or include the Internet, a private network, public network or other configuration that operates using any one or more known communication protocols such as, for example, transmission control protocol/Internet protocol (TCP/IP), Bluetooth®, Wi-Fi, Ultra Wide-Band (UWB), and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples. The network 1160 illustrates an example of one possible communication infrastructure in which the connected devices and vehicles 1103 and/or 1218 (as shown in FIG. 12) may communicate.

Navigation receiver(s) 1140 can include one or more of a global positioning system (GPS) receiver, and/or other related satellite navigation systems such as the global navigation satellite system (GLNSS), Galileo, or other similar systems known in the art of autonomous vehicle operation. Additionally, navigation receiver(s) 1140 can be configured to receive locally based navigation cues to aid in precise navigation through space-restricted areas, such as, for example, in a crowded street, and/or in a distributed beacon environment.

Proximity sensor(s) 1133 may work in connection with navigation receiver(s) 1140 to provide situational awareness to the mobility control module 1105 for autonomous navigation. For example, proximity sensor(s) 1133 may provide a secondary source of data that can indicate the presence of standing or moving water, extreme weather, obstacles partially submerged in standing or moving water, and other functionality. Proximity sensor(s) 1133 may alert the mobility control module 1105 to the presence of sensed obstacles, and provide trajectory information to the mobility control module 1105, where the trajectory information is indicative of moving objects or people that may interact with the vehicle 1103. Sensed obstacles can include other vehicles, pedestrians, animals, structures, curbs, and other random objects.

In some aspects, the AV controller 1100 may perform one or more mitigating actions based, at least in part, on information received from proximity sensor(s) 1133. The trajectory information may include one or more of a relative distance, a trajectory, a speed, a size approximation, a weight approximation, and/or other information that may indicate the physical characteristics of a physical object or person. The mobility control module 1105 may be configured to aggregate information from the navigation receiver(s) 1140, such as current position and speed, along with sensed obstacles from proximity sensor(s) 1133, and interpret the aggregated information to compute a safe path towards a destination such that the vehicle 1103 avoids collisions. In some implementations, proximity sensor(s) 1133 may be configured to determine the lateral dimensions of the path upon which the vehicle 1103 is traveling, (e.g., determining relative distance from the side of a sidewalk or curb), to help aid the mobility control module 1105 in maintaining precise navigation on a particular path.

The interface device 1125 may allow a passenger and/or operator of the vehicle 1103 to receive information associated with any mitigating actions. The interface device 1125 may include a touch screen interface surface (not shown in FIG. 11) configured to provide operational information such as power consumption information, battery health, battery level, etc., that can also control other aspects of the autonomous vehicle 1103, such as braking, acceleration, etc., which may be in communication with and or integral with the navigation interface 1145 such that they share a common touch screen interface.

Mobility control module 1105 may connect with one or more of the drive wheel controller 1115, which in turn may operate one or more traction motors 1120. The mobility control module 1105 may communicate with the drive wheel controller 1115 for providing autonomous and/or semi-autonomous navigation to selected points of interest such as, for example, a location with a navigable level of floodwater. The drive wheel controller 1115 may also control one or more drive mechanisms such as, for example, one or more brushless direct current (DC) motor(s), or another traction motor technology.

FIG. 12 illustrates an example embodiment of an autonomous vehicle fleet operating in accordance with the present disclosure. FIG. 11 and FIG. 12 are referenced in conjunction with one another in the following section. With first attention to FIG. 12, the vehicle 1103 is depicted in water 1205, which may cover a roadway 1210 as vehicle 1103 attempts to traverse the water. In an example scenario, vehicle 1103 may receive capacitive signals from capacitive sensors in the vehicle wheel well of that vehicle, and determine that the first capacitive signal exceeds a threshold value, due to the possible presence of standing or moving floodwater that covers that respective sensor (not shown in FIG. 12). The capacitive water depth sensor system 1135 may receive a second capacitive signal from a second capacitive sensor configured at a higher elevation in the wheel well respective to the first sensor, and determine that the water level is above the second, higher sensor. The water depth sensor system 1135 may further determine a rate in which the water level is rising (that is, a change in water level covering the capacitive sensors with respect to time). Responsive to determining that the water 1205 is higher than the second sensor, (e.g., the second sensor is submerged in the water 1205), the capacitive water depth sensor system 1135 may send the AV controller 1100 first water depth information that includes the depth of the water 1205. The water depth information may also include the rate of change of the water depth. Accordingly, and based on the water depth information, AV controller 1100 may determine a course of mitigating action. As used herein, a mitigating action refers to one or more computer-instructed actions that cause the vehicle to perform steps in accordance with the present disclosure.

For example, the AV controller 1100 may determine that the water 1205 is not the cause of the capacitive sensor signal triggering the alert, but rather the capacitive sensor is covered by an environmental substance such as dirt, mud, road debris, tar, etc. In an embodiment, AV controller 1100 may generate one or more vehicle control instruction(s) for causing the vehicle 1103 to send a sensor clean instruction to a capacitive sensor cleaning system. In one aspect, the sensor clean instruction may be configured to cause an actuator of the capacitive sensor cleaning system (not shown in FIG. 12) to dispense a cleansing solution (not shown in FIG. 12) onto the capacitive sensors.

The AV controller 1100 may also update a vehicle maintenance log (not shown in FIG. 12), which may be stored in memory 1155, with a maintenance instruction for sensor maintenance during a future AV maintenance operation. AV maintenance operations may be performed by vehicle maintenance operators from a centralized location. For example, vehicle 1103 may periodically navigate to the centralized location for regular or instruction-triggered vehicle maintenance. In an example, the vehicle maintenance log may be used as input data that triggers such a maintenance visit.

In another example embodiment, the mitigating action may include instructions that cause the vehicle 1103 to navigate to a car wash for self-cleaning, which may clear the sensor system of any debris or environmental substance.

The vehicle 1103 may not be experiencing a false signal due to dirty capacitive sensors, but rather may be surrounded by static or rising surface water 1205. According to another example embodiment, performing the mitigating action can include generating one or more instructions, via mobility control module 1105, that cause the vehicle 1103 to move/return to a location with operable water depth (e.g., a location 1211). The operable water depth may be a water depth known to be navigable by the vehicle 1103 based on known configuration parameters of the vehicle 1103. For example, vehicle height from the road (that is, clearance between the road surface and the undercarriage of vehicle 1103), position of critical electrical components onboard vehicle 1103, such as motors, circuitry, etc., and other factors associated with vehicle 1103 design may be known and tested prior to deployment in the field. In one aspect, operable water depth may be a water depth determined to be less than a threshold water depth. The threshold water depth can be a maximum water depth over which vehicle 1103 is not designed to operate.

AV controller 1100 may determine that the location 1211 is associated with operable water depth in various ways. In one example, the determination may be based on a persistent memory of water depths that were observed (detected) and saved to memory by capacitive water depth sensor system 1135. The water depth information may be recorded with respect to time, with respect to the vehicle location, and/or based on information received from the autonomous vehicle fleet control server 1170. In this example, if vehicle 1103 traversed water at a 12″ depth within the last three minutes at the location 1211, which may be a relatively short distance (e.g., 15 feet, 100 yards, etc.) from a present position of vehicle 1103, the AV controller 1100 may determine that the prior location 1211 is likely to be less than the threshold water depth for safe vehicle operation. In an example embodiment, a threshold water depth may be 18″ or less. Accordingly, AV controller 1100 may determine that 3 minutes ago, water depth at location 1211 was 12″, and thus within a range for operable water depth. The AV controller 1100 may base the determination on a rate of rising water, weather conditions, camera information, data received from the fleet control server 1170, and via other factors that may provide a predictive data set that can predict a water depth at a remote location such as location 1211.

AV controller 1100 may further determine that emergency help may be needed from another vehicle, such as a tow vehicle (not shown). Accordingly, AV controller 1100 may send a message to control system 1170 requesting emergency help. In an embodiment, the message sent to control system 1170 may include location information, vehicle information, water depth information, nature of the emergency, or other contemplated information. Autonomous fleet control server 1170 may also be disposed in communication with emergency services associated with a city, region, etc. such that information received from the capacitive sensor system is shared with emergency services, and the fleet control server 1170 can receive traffic, emergency vehicle information, and the like, and response messages to the vehicle 1103 can include the information.

In another example embodiment, vehicle 1103 may receive a response message from autonomous vehicle fleet control server 1170 indicating a route recommendation for vehicle 1103. Accordingly, vehicle 1103 may move/return to the location 1220 based at least in part on the operable water depth information 1240 that describes water depth information at location 1220. The response message may include location information 1230, indicative of the location 1220, and water depth information 1240 that can include value(s) associated with water depth at location 1220. The message may further include route information 1235, which can provide GPS information associated with a route 1225 for navigating to the location 1220, water depth information 1240 associated with the location 1220, and/or include vehicle identification information (e.g., the vehicle ID 1245) associated with a second autonomous vehicle 1218 of fleet 1116 that may provide such information. FIG. 12 depicts the second AV 1218 associated with vehicle fleet 1116 navigating floodwaters 1215, after having traversed the location 1220, saved water depth information 1240 to a persistent memory onboard vehicle 1218 and/or server(s) 1170, and provided water depth information 1240, rout information 1235, location information 1230, and/or vehicle ID information 1245 to the fleet control server 1170.

In another example embodiment, the mitigating action may include instructions for performing body height adjusting operation. In this example, vehicle 1103 may include one or more lifts configured to extend a clearance between the road 1210 and vehicle body portions that include sensors associated with the capacitive water depth sensor system 1135. For example, the AV controller 1100 may cause the mobility control module 1105 to instruct body lift actuators (not shown in FIG. 11 or 12) to lift the vehicle body, and thus, increase the threshold water depth. Such an operation may also increase the operable water depth such that vehicle 1103 can traverse the water 1205.

The AV controller 1100 may perform other mitigating actions based on water depth information, including instructing one or more vehicle systems to disengage, power down, or otherwise, prepare for imminent water contact. By powering down, the AV controller 1100 may mitigate possible damage associated with water covering critical or sensitive engine components.

In another example, the mitigating action may include providing power to one or more window actuators to provide emergency vehicle access or means for exit in a catastrophic flood event.

A mitigating action may further include causing a water diversion mechanism (Not shown in FIG. 11 or 12) to deploy on an underside of the vehicle 1103. In one example embodiment, the AV controller 1100 may engage a mechanical arm that positions a V-shaped or U-shaped water diverter from a generally flush position with respect to the undercarriage, such that it diverts water away from one or more electrical components disposed on the underside of the vehicle 1103 when the vehicle is traveling in a forward direction.

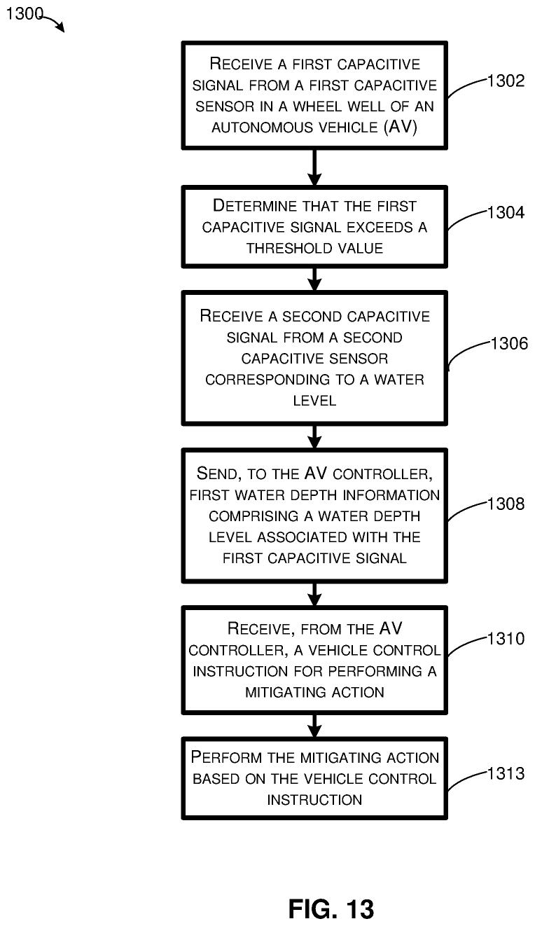

FIG. 13 is a flowchart of another example method of the present disclosure related to controlling an autonomous vehicle using the capacitive water depth sensor system in accordance with the present disclosure.

At step 1302, the AV controller 1100 may receive a first capacitive signal from a first capacitive sensor in a vehicle wheel well of an autonomous vehicle (AV). The AV may be, for example, vehicle 1103 as shown in FIG. 12.

At step 1304, the capacitive water depth sensor system 1135 may determine that the first capacitive signal exceeds a threshold value.

At step 1306, the capacitive water depth sensor system 1135 may receive a second capacitive signal from a second capacitive sensor corresponding to a water level.

At step 1308, the capacitive water depth sensor system 1135 may send, to AV controller 1100, first water depth information comprising a water depth level associated with the first capacitive signal.

At step 1310, the capacitive water depth sensor system 1135 may receive, from the AV controller 1100, a vehicle control instruction for performing a mitigating action.

At step 1313, the capacitive water depth sensor system 1135 may perform the mitigating action based on the vehicle control instruction.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein.

An implementation of the devices, systems, and methods disclosed herein may communicate over a computer network. A “network” and a “bus” is defined as one or more data links that enable the transport of electronic data between computer systems and/or modules and/or other electronic devices. When information is transferred or provided over a network, a bus, or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general-purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application-specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments. Although certain aspects of various embodiments may have been described using a singular word or phrase (such as “a signal” or “a processor”) it should be understood that the description may be equally applicable to plural words or phrases (such as “signals” and “processors”).

That which is claimed is:

1. A method comprising:
receiving, by one or more processors, a first capacitive signal from a first capacitive sensor in a wheel well of an autonomous vehicle (AV);
determining that the first capacitive signal exceeds a threshold value;
receiving a second capacitive signal from a second capacitive sensor corresponding to a water level;
sending, to an AV controller, first water depth information comprising a water depth level associated with the first capacitive signal;
receiving, from the AV controller, a vehicle control instruction for performing a mitigating action; and
performing the mitigating action based on the vehicle control instruction.

2. The method of claim 1, further comprising:
determining that a highest level capacitive signal is received from the highest mounted capacitive sensor, corresponding to a highest water level; and
sending, to the AV controller, second water depth information comprising an operative water depth associated with the highest mounted capacitive sensor capacitive signal.

3. The method of claim 1, wherein performing the mitigating action comprises:
moving the AV to a location with an operable water depth, wherein the operable water depth is less than a threshold water depth.

4. The method of claim 3, wherein performing the mitigating action further comprises:
responsive to receiving the second capacitive signal from the second capacitive sensor, sending a message to an AV fleet control system associated with an AV fleet.

5. The method of claim 4, wherein performing the mitigating action comprises:
receiving, from the AV fleet control system, a response message indicating a route recommendation for moving the AV to the location with the operable water depth.

6. The method of claim 4, wherein the response message is based on second AV water level information, and provides information indicating at least one of:
a location of a second AV and a water depth level at the location of the second AV; and
second AV water depth information comprising the second AV water depth level, wherein a second AV measures the second AV water depth at the location with the water depth associated with a highest mounted capacitive sensor capacitive signal of the second AV.

7. The method of claim 1, wherein performing the mitigating action based on the vehicle control instruction further comprises:
determining that the first capacitive signal exceeds a threshold value;
determining that the first capacitive signal corresponds to an environmental substance; and
transmitting a message to the AV controller indicating that the first capacitive sensor is covered in the environmental substance.

8. The method of claim 1, wherein the performing the mitigating action based on the vehicle control instruction comprises:
sending a sensor clean instruction to a capacitive sensor cleaning system, the sensor clean instruction configured to cause an actuator of the capacitive sensor cleaning system to dispense a cleaning solution onto the first capacitive sensor; and
updating a vehicle maintenance log with a maintenance instruction for sensor maintenance during a future AV maintenance operation.

9. The method of claim 1, wherein performing the mitigating action based on the vehicle control instruction comprises:
sending a help request message that requests emergency assistance.

10. The method of claim 1, wherein performing the mitigating action based on the vehicle control instruction comprises:
performing, by way of the AV controller, a body height adjusting operation.

11. The method of claim 10, wherein performing the body height adjusting operation comprises:
determining a threshold water depth associated with a current body height;
determining a second body height within a range of body height adjustments associated with a body of the AV, wherein the second body height is associated with a second threshold water depth; and
actuating a body lift actuator that modifies a body height clearance of the body of the AV to the second body height.

12. A system comprising:
an autonomous vehicle (AV) controller; and
a memory and a processor in communication with the AV controller and a first capacitive sensor, the processor configured to:
receive a first capacitive signal from a first capacitive sensor in a wheel well of an autonomous vehicle (AV);
determine that the first capacitive signal exceeds a threshold value;
receive a second capacitive signal from a second capacitive sensor corresponding to a water level;
send, to the AV controller, first water depth information comprising a water depth level associated with the first capacitive signal;
receive, from the AV controller, a vehicle control instruction for performing a mitigating action; and
perform the mitigating action based on the vehicle control instruction.

13. The system of claim 12, wherein the processor is further configured to:
determine that a highest level capacitive signal is received from the highest mounted capacitive sensor, corresponding to a highest water level; and
send, to the AV controller, second water depth information comprising an operative water depth associated with the highest mounted capacitive sensor capacitive signal.

14. The system of claim 13, wherein the AV controller is further configured to:
move the AV to a location with an operable water depth, wherein the operable water depth is less than a threshold water depth.

15. The system of claim 14, wherein the AV controller is further configured to:
responsive to receiving the second capacitive signal from the second capacitive sensor, send a message to an AV fleet control system associated with an AV fleet.

16. The system of claim 15, wherein the AV controller is further configured to:
receive, from the AV fleet control system, a response message indicating a route recommendation for moving the AV to the location with the operable water depth.

17. The system of claim 16, wherein the response message is based on second AV water level information, wherein the response message provides information indicating at least one of:
a location of a second AV and a water depth level at the location of the second AV; and
the second AV water depth information comprising the second AV water depth level, wherein the second AV measures the second AV water depth at the location with the water depth associated with a highest mounted capacitive sensor capacitive signal of the second AV.

18. The system of claim 12, wherein the processor is further configured to:
determine that the first capacitive signal exceeds a threshold value;
determine that the first capacitive signal corresponds to an environmental substance; and
transmit a message to the AV controller indicating that the first capacitive sensor is covered in the environmental substance.

19. The system of claim 18, wherein the processor is further configured to:
send a sensor clean instruction to a capacitive sensor cleaning system, the sensor clean instruction configured to cause an actuator of the capacitive sensor cleaning system to dispense a cleaning solution onto the first capacitive sensor; and
update a vehicle maintenance log with a maintenance instruction for sensor maintenance during a future AV maintenance operation.

20. A non-transitory computer-readable storage medium in a vehicle control module, the computer-readable storage medium having instructions stored thereupon which, when executed by a processor, cause the processor to:
receive a first capacitive signal from a first capacitive sensor in a wheel well of an autonomous vehicle (AV);
determine that the first capacitive signal exceeds a threshold value;
receive a second capacitive signal from a second capacitive sensor corresponding to a water level;
send, to the AV controller, first water depth information comprising a water depth level associated with the first capacitive signal;
receive, from the AV controller, a vehicle control instruction for performing a mitigating action; and
perform the mitigating action based on the vehicle control instruction.
